(19) United States
(12) Patent Application Publication
(10) Pub. No.: US 2026/0158666 A1
(43) Pub. Date: Jun. 11, 2026

(54) INTELLIGENT ROBOTIC COMMUNICATION SYSTEM

(71) Applicant: Zayed University, Dubai (AE)

(72) Inventors: Farkhund Iqbal, Abu Dhabi (AE); Patrick Hung, Ontario (CA); NANNAPAT MEEMONGKOLKIAT, Bangkok (TH)

(73) Assignee: Zayed University, Dubai (AE)

(21) Appl. No.: 18/977,779

(22) Filed: Dec. 11, 2024

(51) Int. Cl. B25J 11/00; B25J 19/02

(52) U.S. Cl. CPC B25J 11/0015; B25J 11/001; B25J 19/023

(57) ABSTRACT

An apparatus, includes a computing device, a display screen, a compartment area; and a camera. The computing device receives electronic communications that allow the computing device to change the display screen to show a particular emotion. The computing device moves from one location to another location. The computing device takes electronic images via the camera. The electronic images determine a type of activity being conducted by a person, and

the type of activity is determined by a particular time.

### BACKGROUND

Humanoid social robot currently exists and function as companion devices that connect to cloud services which enhance productivity through networking, multimedia, and sensory technologies. However, there presently no humanoid-style social robots that can electronically communicate that take into consideration cultural differences. Furthermore, there are also no current humanoid-style robots that can take into consideration cultural difference and provide an electronic medication management system while taking into account various factors such as religion, tradition, and race in robot presentation and behavior.

### BRIEF DESCRIPTION OF DRAWINGS

FIG. 1 is a diagram of an example flowchart;

FIG. 2 is a diagram of an example flowchart;

FIG. 3 is a diagram of an example environment;

FIG. 4 is a diagram of an example environment;

FIG. 5 is a diagram of an example screenshot;

FIG. 6 is a diagram of example electronic facial displays;

FIG. 7 is a diagram of an example environment;

FIG. 8 is a diagram of an example electronic analysis process;

FIG. 9 is a diagram of an example relationship chart;

FIG. 10 is a diagram of an example flow chart;

FIGS. 11, 12, and 13 are diagrams of example screenshots;

FIG. 14 is a diagram of an example networking environment; and

FIG. 15 is a diagram of an example computer.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein are for an electronic hardware device that has electronic features that allow for social interactions with people based on various cultural, religious, and social traits associated with a particular person. In embodiments, the systems, devices, and/or methods described herein allow for such interactive social interactions to allow for providing a dispensing system that can be used to provide food, medications, and/or other items.

In embodiments, the systems, devices, and/or methods described herein provide for devices that can reduce the computing and human resources needed in time-consuming processes associated with neuro-rehabilitation therapies. In embodiments, such devices can be used in non-contact, hands-off therapeutic interactions with the patient, exploiting embodiment, emotions, dialogues, personality, user models and socially situated-learning.

In embodiments, by using the interactive features, the systems, devices, and/or methods described herein can deliver items to a person, including medication inside a smart delivery box. In embodiments, the delivery box may contain medication or other items for a person. In embodiments, the delivery box may be linked to a device (e.g., a robot) via wireless communication such as Bluetooth and NFC. Accordingly, the device may help to provide reminders, receive dispensing information, and analyze medication logs.

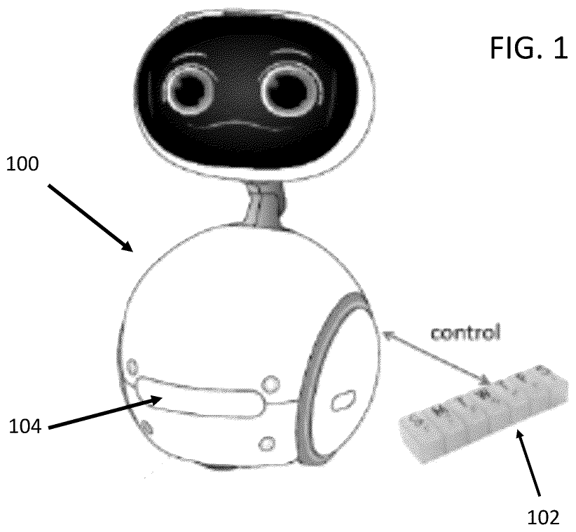

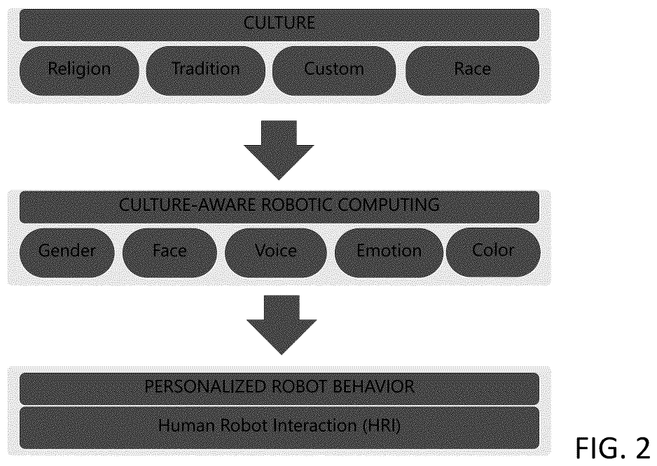

FIG. 1 is an example diagram of device 100 with delivery box 102. In embodiments, device 100 may have a compartment 104 which allows for delivery box 102 to be placed within device 100. As shown in FIG. 1, device 100 may be a robot device that can be stationary or have the ability to move from one location to another. In embodiments, as described further, device 100 may include one or more computing processes that allow for device 100 to interact with a person based on that person's ethnic, religious, and cultural background.

FIG. 2 is an example diagram of flowchart 200. As shown in FIG. 2, flowchart 200 shows an overview of an example process in which electronic information about culture (which can include religion, tradition, custom, and race etc.) is inputted into a computing system which is shown to be a culture-aware robotic computing device in FIG. 2. In embodiments, the computing system may determine different electronic outputs (e.g., verbal, textual, graphical) that are associated with gender, race, voice, emotion, and color, etc. Furthermore, as shown in FIG. 2, additional personalized electronic communications (e.g., robotic behavior) may be conducted by the computing system that are interactions with a person.

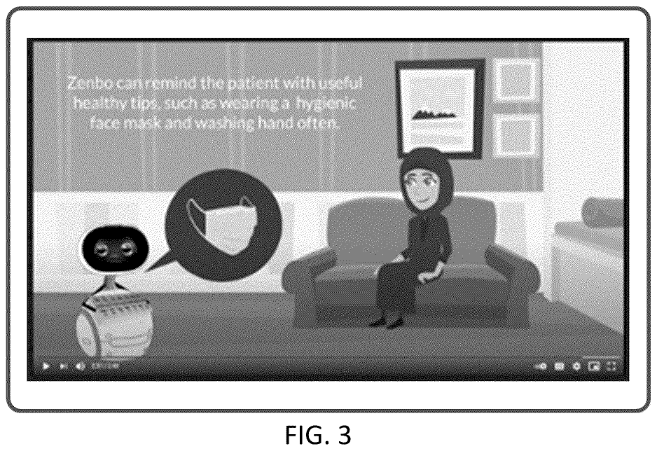

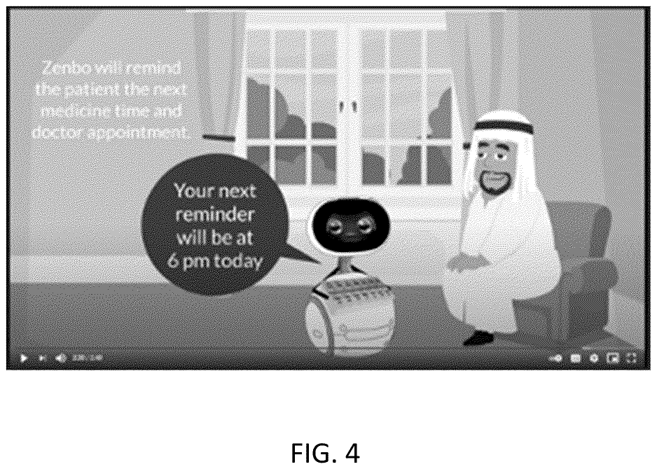

FIG. 3 describes an example environment in which a computing device is interacting with a person. As shown in FIG. 3, the computing device (shown as a robot) provides information about hand washing and wearing a mask. FIG. 4 describes another example environment in which a computing device is interacting with another person. As shown in FIG. 4, the computing device (shown as a robot) is providing information about an appointment to the user.

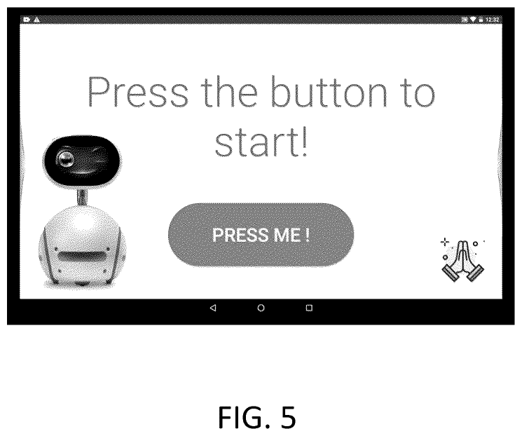

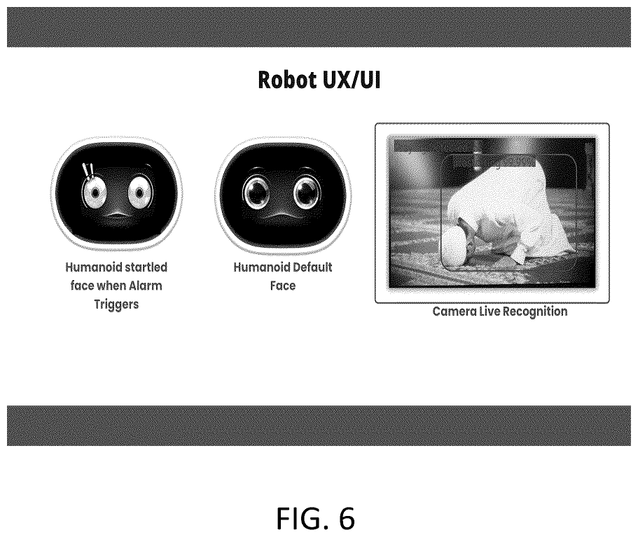

FIG. 5 describes an example screenshot for starting a computing device and its interactions with a person. In embodiments, the screenshot may be displayed on the computing device (e.g., a robot) or on a user device (e.g., a smartphone) that can electronically communicate with the computing device. FIG. 6 shows example expressions generated by the computing device. This includes an expression of when the computing device is turned on and would be a default expression while the other expression is one that occurs when a particular type of notification is needed to be provided by the computing device. Also, as shown in FIG. 6, an image of a person is shown and is how that image would be seen by the computing device's camera system.

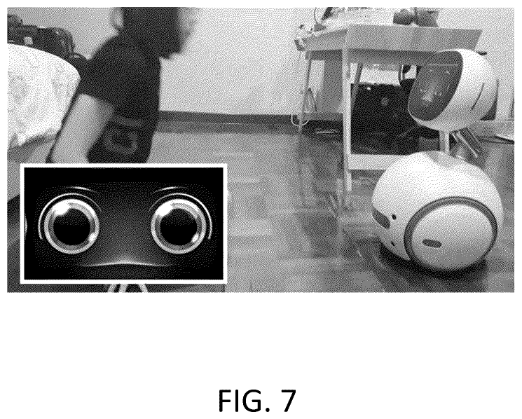

FIG. 7 shows another example environment that shows an interaction between a person and a computing device (shown as a robot). As shown in FIG. 7, the expression of the computing device's electronic face is shown.

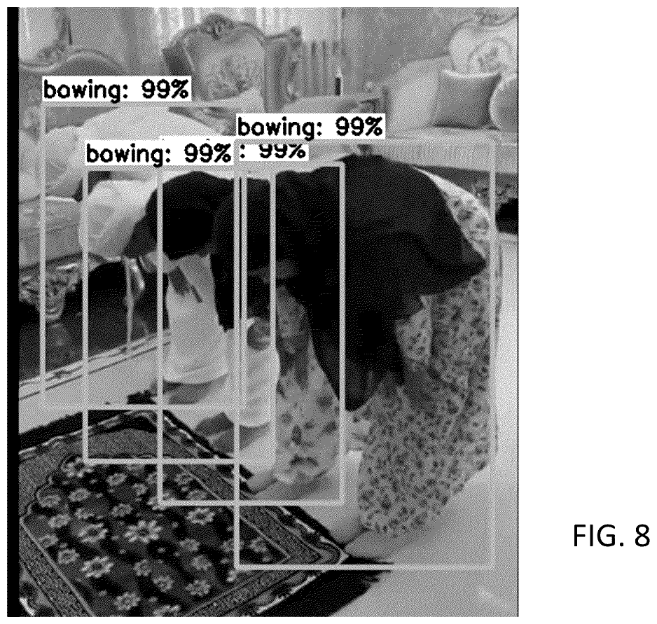

FIG. 8 shows an example image as seen by a computing device. As shown in FIG. 8, the computing device camera is seeing electronic imagery (e.g., a video or multiple images) of two people bowing. In embodiments, the computing device determines with 99% accuracy that the two people are bowing. Based on the bowing and the style of bowing, the computing device is able to determine that the two people are praying. In embodiments, the computing device may be a robot that has a camera that sees the electronic imagery, body moments and postures and makes the determination that the people in the imagery are bowing and that the sequence of movements/postures indicates praying called ‘SALAT’. In embodiments, the computing device may determine that the imagery is bowing based on one or more sub-systems that provide electronic information to the computing device that the sequence of movements/postures are prayers.

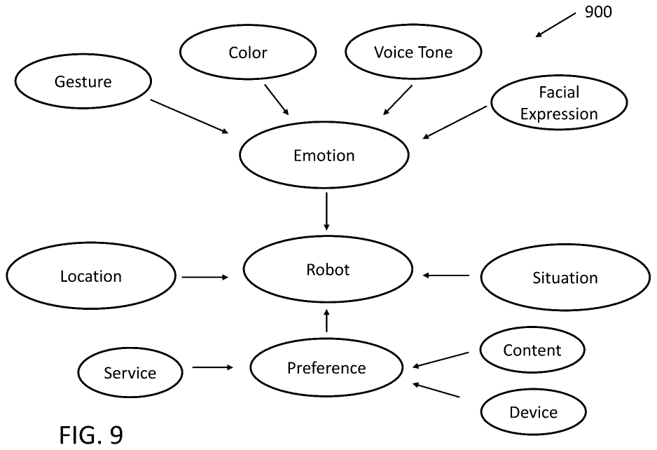

FIG. 9 shows an example relationship chart 900 that describes the interaction of different electronic elements contributing to the emotional and functional behavior of a humanoid social robot. As shown in FIG. 9, a robot (e.g., device 100) is controlled by inputs from one or more inputs that include the emotion sub-system, the location sub-system, the situation sub-system, and the preference sub-system. In embodiments, the emotion sub-system determines emotions which are influenced by various robot attributes like gesture, color (light on robot facial display), voice tone (which may be based on the location of the robot since different languages have different tone levels, culturally) and facial expression. In embodiments, these attributes are divided into Software Components and Hardware Components. In embodiments, the robot (e.g., device 100) is the hardware system that interacts with the environment and users. In embodiments, the robot is associated with (1) physical actions/movements of the robot; (2) environmental or contextual information; (3) sensory surroundings; and (4) the environment within which the robot is located.

In embodiments, the situations sub-system is based on interactions between the humanoid robot, the user, and the environment. In embodiments, the situations sub-system informs the robot's preferences. In embodiments, the preference sub-system is divided into three categories. The first category is content preference which is based on electronic information or entertainment content based on user preferences. The second category is service preference which is based on functional services desired by the user. The third category is device preference which is based on configuration or settings adjustments. In embodiments, these preferences further influence content, service, and device settings.

In embodiments, the flow sub-system determines how the robot operates in a specific location and interacts with the user. Based on the situation and contextual data, the flow sub-system adapts the robot's behavior and preferences to create a tailored experience for the user.

In embodiments, relationship chart 900 allow for enhancing the user experience by aligning robot emotions, behaviors, and preferences with situational context and human interaction. In embodiments, the tailored electronic experience for the user may include a combination of different services with different emotions and with different situations. In embodiments, the robot may at 10:00 am (time 1) provide a happy face and a first electronic communication with a first tone (tone 1), and is communicating to a person to exercise (situation 1). At 2:00 pm (time 2), the robot may use its learning systems to determine whether a person is supposed to be praying (situation 2) and provides a more somber tone (tone 2) and a different electronic face. At 5:00 pm (time 3), the robot may use its learning system to determine that a person is to take medication. At 5:00 pm, the robot may use its electronic camera to determine whether the person conducting an activity that would be taking a pill. The robot can also determine if the person is taking the pill from a pill box (based on the shape of the pill box and/or the location of the pill box which may be a separate location than the robot). The robot can either provide no communication or can still provide a reminder communication to the user even if the person is determined to be taking their medication.

In a non-limiting example, a robot receives electronic information on the location of the robot to be in London, United Kingdom. In addition, the robot receives electronic information on user preferences that include media content associated with children educational music, a preference on when the robot is to interact with the person (e.g., from 3 pm to 4 pm), and device preference on how the robot should behave (e.g., the type of graphical image on the robot's electronic face.

In this non-limiting example, the robot has electronic access to an emotion sub-system that provides electronic information which in this example provides electronic information on a child's expressions, tones that are associated with a particular age group, and the color of the robot's electronic face. In this non-limiting example, the robot is used to help remind a child to watch a television show. In doing so, the robot has a generated voice that would be used for a person of that particular age group (e.g., 6 to 9 years old).

In another non-limiting example, a robot receives electronic information of the robot to be in Tokyo, Japan. In this other non-limiting example, the robot receives electronic preference information that the robot is to provide notifications for a person when it is time to take a particular mediation. In this other non-limiting example, the robot is provided time preferences for when the medication should be taken (e.g., 10 am, 1 pm, etc.) and/or how many times in the day (e.g., after breakfast, before lunch, etc.). In this non-limiting example, the robot receives electronic information on physical behavior of the person that would allow the robot to understand (based on visual electronic information received via a camera on the robot) that a person is eating and also determine the time of the day. Thus, the robot can determine to provide an electronic communication to the person to take their medication. In this non-limiting example, the medication pill box may be located in a compartment-type area in the robot's body that allows the user to have access. If the pill box is located in a robot body compartment area, the robot may have electronic sensors that determine touching of the compartment area also any change in weight due to removal of medication. Alternatively, the pill box may be located somewhere that is accessible to the person. In this non-limiting example, the robot may also determine at a later time of the day that the same person is to take a liquid medication. At that particular time, the robot may approach the user and determine via the robot's camera system that the person is taking a liquid from a particular sized bottle (which would be a medicine rather than a bottle of orange juice). Based on the robot's learning and AI capabilities, the robot can determine the type of bottle and liquid to determine if a reminder is needed or not.

In an additional non-limiting example, a robot is to provide notifications for a person when it is time to exercise. In this additional non-limiting example, the robot is provided with electronic information on one or more types of movements that would an exercise (for example, doing push-ups). In this additional non-limiting example, at 5 pm, the robot moves to a particular location to determine whether a person is doing a particular exercise. Based on electronic imagery, the robot may determine that the person is sitting on a chair and watching television. The robot may provide an audible voice that indicates to the person that it is time to do exercises. At 5:30 pm, the robot may go to another location (which is determined by the robot to be the location of the exercise regime) and be provided with electronic images/video of a person moving up and down. The robot may receive the electronic information and determine that the person is doing push-ups and provide either no further communication or a congratulatory communication to the person (e.g., “good job”).

In another non-limiting example, a robot is to provide notifications for a person to take a blood thinner medication (or any other type of medication). The robot is provided with electronic information on the time for blood thinner medication. In this additional non-limiting example, the robot is also provided electronic information about religious holidays and also any periods of time where food intake is not permitted (e.g., for religious or other dietary reasons). In embodiments, the robot may change its notification to a user based on other particular times relating to food intake requirements and holidays. Thus, the robot may approach a user at, for example, at one time when there is no holiday, and approach the user at a different time when there is a holiday.

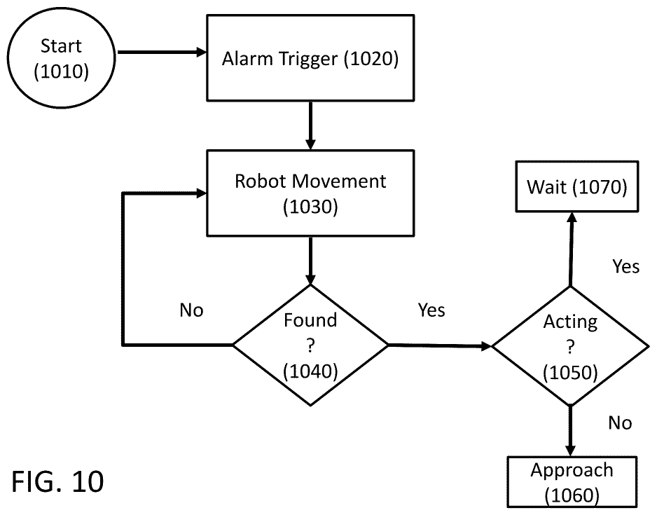

FIG. 10 shows example flowchart 1000. In embodiments, flowchart 1000 may be conducted by a computing device (such as a robot). At step 1010, the computing device is started and which may include pressing a button or a remote start (e.g., using a smartphone). Once powered on, at step 1020 an alarm trigger may occur on the computing device. In embodiments, the alarm trigger may be an electronic notification to the computing device that a particular activity is about to occur within a certain period of time of the electronic notification. At step 1030, the computing device (e.g., the robot) moves to a particular location that is close to the person to whom the computing device is to provide the electronic notification.

At step 1040, the computing device determines whether it has found the person to whom the computing device is to provide the electronic notification. If the computing device has not found the person (1040—NO), then the computing device goes to step 1030 and continues to move to look for the person. If the computing device has found the person (1040—YES), then the computing device determines, at step 1050, if the person is acting in a particular way. For example, if the person is not acting in a particular way, the computing device may determine (1050—NO) to approach the person at step 1060. If the computing device has found the person is acting in a particular way (1050—YES), then the computing device may wait. For example, if the person is taking their medication, the computing device may determine to wait and not provide a reminder communication.

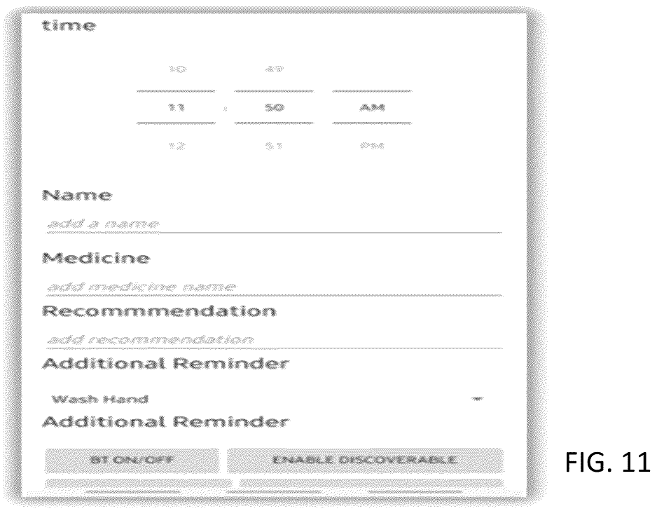

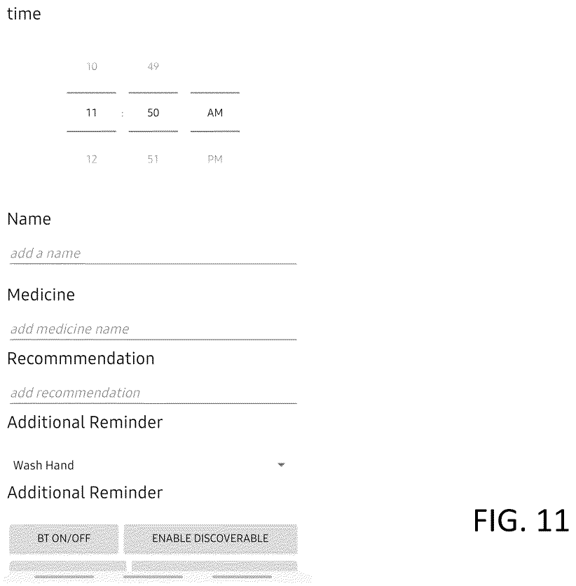

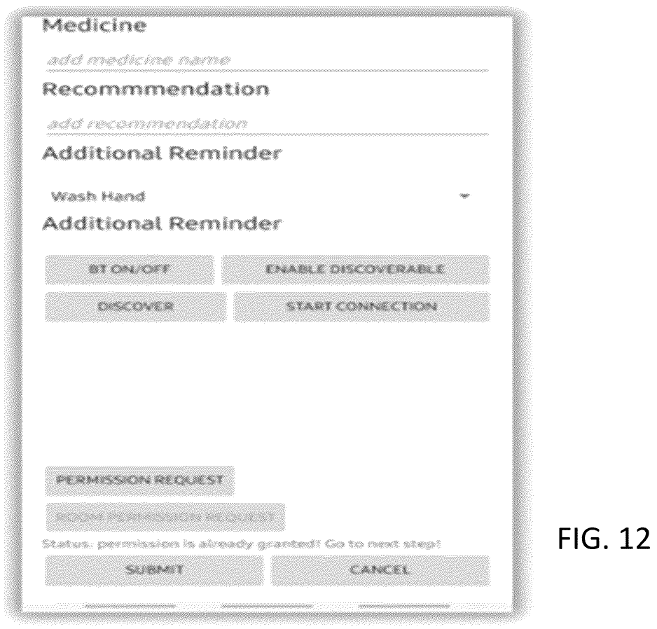

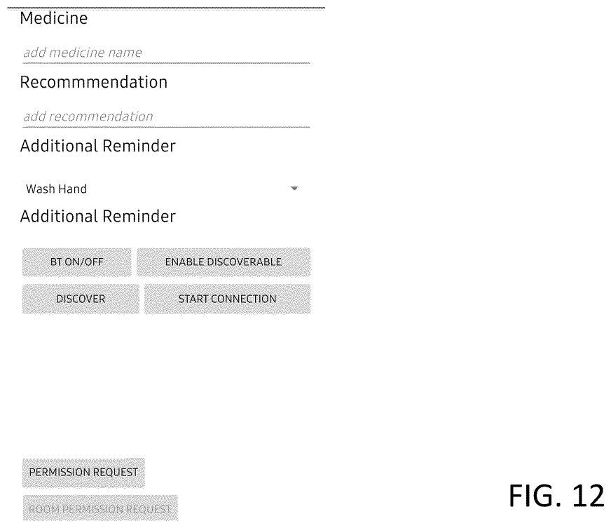

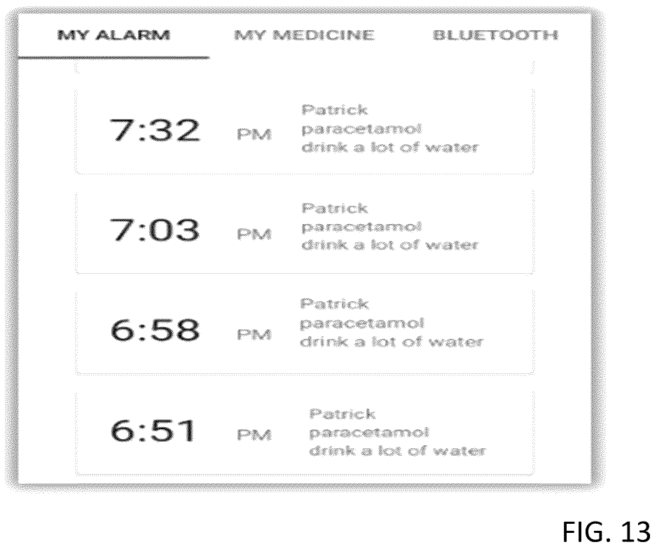

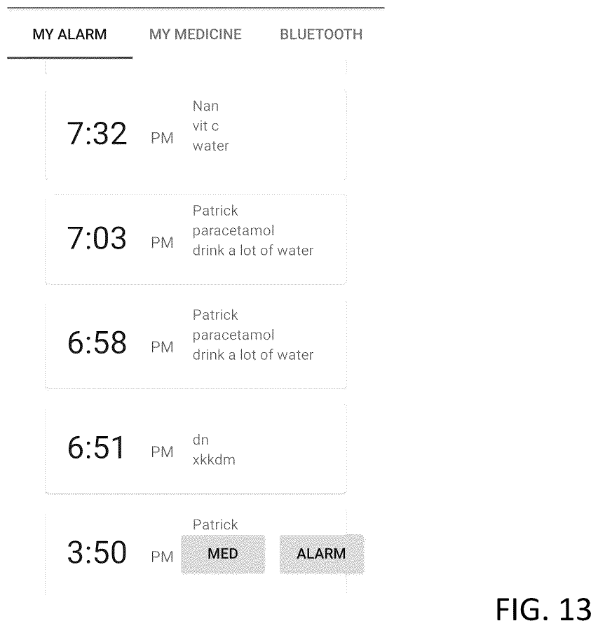

FIGS. 11, 12, and 13 describe screenshots of electronic pages associated with an electronic application that can be used to control the actions of the computing device. In embodiments, the electronic application may be displayable on the computing device

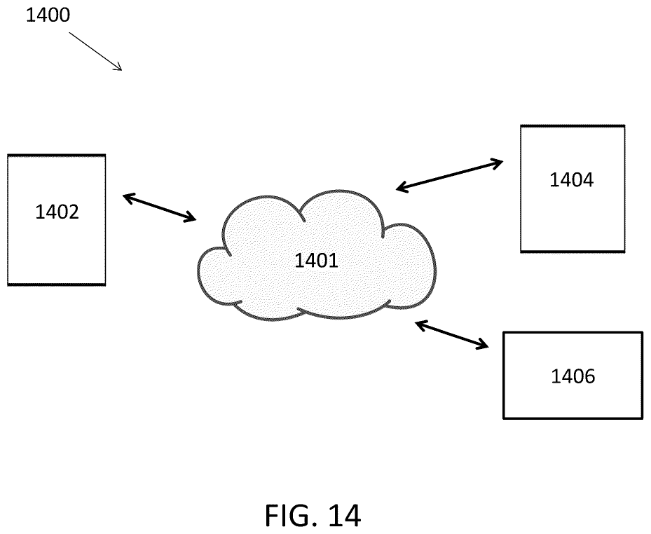

FIG. 14 is a diagram of example environment 1400 in which systems, devices, and/or methods described herein may be implemented. FIG. 14 shows network 1401, user device 1402, device 1404, and server 1406.

Network 1401 may include a local area network (LAN), wide area network (WAN), a metropolitan network (MAN), a telephone network (e.g., the Public Switched Telephone Network (PSTN)), a Wireless Local Area Networking (WLAN), a Wi-Fi, a hotspot, a Light fidelity (Li-Fi), a Worldwide Interoperability for Microware Access (WiMax), an ad hoc network, an intranet, the Internet, a satellite network, a Geographical Position System (GPS) network, a fiber optic-based network, and/or combination of these or other types of networks. Additionally, or alternatively, network 1400 may include a cellular network, a public land mobile network (PLMN), a second generation (2G) network, a third generation (3G) network, a fourth generation (4G) network, a fifth generation (5G) network, and/or another network.

In embodiments, network 1401 may allow for devices describe any of the described figures to electronically communicate (e.g., using emails, electronic signals, Universal Resource Locator (URL) links, web links, electronic bits, fiber optic signals, wireless signals, wired signals, etc.) with each other so as to send and receive various types of electronic communications.

User device 1402 may include any computation or communications device that is capable of communicating with a network (e.g., network 1401). For example, user device 1402 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a desktop computer, a laptop computer, a tablet computer, a camera, a personal gaming system, a television, a set top box, a digital video recorder (DVR), a digital audio recorder (DUR), a digital watch, a digital glass, or another type of computation or communications device.

User device 1402 may receive and/or display content. The content may include objects, data, images, audio, video, text, files, and/or links to files accessible via one or more networks. Content may include a media stream, which may refer to a stream of content that includes video content (e.g., a video stream), audio content (e.g., an audio stream), and/or textual content (e.g., a textual stream). In embodiments, an electronic application may use an electronic graphical user interface to display content and/or information via user device 1402. User device 1402 may have a touch screen and/or a keyboard that allows a user to electronically interact with an electronic application. In embodiments, a user may swipe, press, or touch user device 1402 in such a manner that one or more electronic actions will be initiated by user device 1402 via an electronic application.

User device 1402 may include a variety of applications, such as, for example, an e-mail application, a telephone application, a camera application, a video application, a multi-media application, a music player application, a visual voice mail application, a contacts application, a data organizer application, a calendar application, an instant messaging application, a texting application, a web browsing application, a blogging application, and/or other types of applications (e.g., a word processing application, a spreadsheet application, etc.). In embodiments, user device 1402 may send and receive electronic information from device 1404 via network 1401. In embodiments, user device 1402 may send and receive electronic information from server 1406 via network 1401.

Device 1404 may include any computation or communications device that is capable of communicating with a network (e.g., network 1401). For example, device 1404 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a desktop computer, a laptop computer, a tablet computer, a camera, a personal gaming system, a television, a set top box, a digital video recorder (DVR), a digital audio recorder (DUR), a digital watch, a digital glass, or another type of computation or communications device.

Device 1404 may receive and/or display content. The content may include objects, data, images, audio, video, text, files, and/or links to files accessible via one or more networks. Content may include a media stream, which may refer to a stream of content that includes video content (e.g., a video stream), audio content (e.g., an audio stream), and/or textual content (e.g., a textual stream). In embodiments, an electronic application may use an electronic graphical user interface to display content and/or information via user device 1402. Device 1404 may have a display screen for showing an electronic display that indicates various emotions (e.g., smiling) and various facial features (e.g., eyes, mouth, etc.). Device 1404 may move around and have features that make device 1404 appear to be a robot. In embodiments, device 1404 may send and receive electronic information from user device 1402 via network 1401. In embodiments, device 1404 may send and receive electronic information from device 1406 via network 1401. In embodiments, device 1404 may be device 100.

Device 1406 may include any computation or communications device that is capable of communicating with a network (e.g., network 1401). Device 1406 is a server computing device that can store electronic information, such as objects, data, images, audio, video, text, files, and/or links to files. Device 1406 may send and receive electronic information from user device 1402 via network 1401. In embodiments, device 1406 may send and receive electronic information from device 1404 via network 1401.

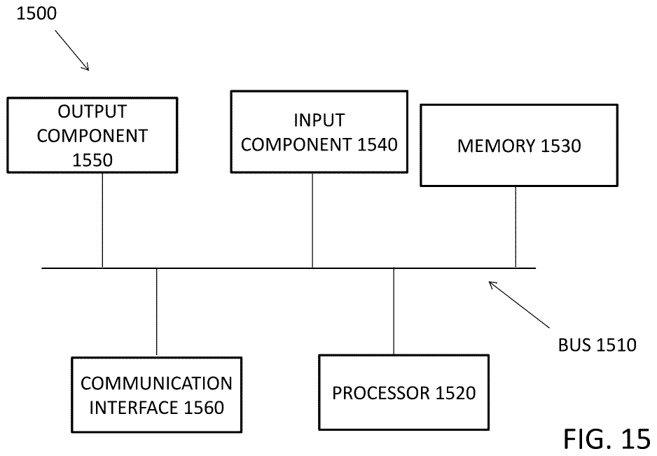

FIG. 15 is a diagram of example components of a device 1500. Device 1500 may correspond to user device 1402, device 1404, and server 1406. Alternatively, or additionally, user device 1402, device 1404, and server 1406 may include one or more devices 1500 and/or one or more components of device 800.

As shown in FIG. 15, device 1500 may include a bus 1510, a processor 1520, a memory 1530, an input component 1540, an output component 1550, and a communications interface 1560. In other implementations, device 1500 may contain fewer components, additional components, different components, or differently arranged components than depicted in FIG. 15. Additionally, or alternatively, one or more components of device 1500 may perform one or more tasks described as being performed by one or more other components of device 1500.

Bus 1510 may include a path that permits communications among the components of device 1500. Processor 1520 may include one or more processors, microprocessors, or processing logic (e.g., a field programmable gate array (FPGA) or an application specific integrated circuit (ASIC)) that interprets and executes instructions. Memory 1530 may include any type of dynamic storage device that stores information and instructions, for execution by processor 1520, and/or any type of non-volatile storage device that stores information for use by processor 1520. Input component 1540 may include a mechanism that permits a user to input information to device 1500, such as a keyboard, a keypad, a button, a switch, voice command, etc. Output component 1550 may include a mechanism that outputs information to the user, such as a display, a speaker, one or more light emitting diodes (LEDs), etc.

Communications interface 1560 may include any transceiver-like mechanism that enables device 1500 to communicate with other devices and/or systems. For example, communications interface 1560 may include an Ethernet interface, an optical interface, a coaxial interface, a wireless interface, or the like.

In another implementation, communications interface 1560 may include, for example, a transmitter that may convert baseband signals from processor 1520 to radio frequency (RF) signals and/or a receiver that may convert RF signals to baseband signals. Alternatively, communications interface 1560 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communications interface 1560 may connect to an antenna assembly (not shown in FIG. 8) for transmission and/or reception of the RF signals. The antenna assembly may include one or more antennas to transmit and/or receive RF signals over the air. The antenna assembly may, for example, receive RF signals from communications interface 1560 and transmit the RF signals over the air, and receive RF signals over the air and provide the RF signals to communications interface 1560. In one implementation, for example, communications interface 1560 may communicate with network 1401.

As will be described in detail below, device 1500 may perform certain operations. Device 1500 may perform these operations in response to processor 1520 executing software instructions (e.g., computer program(s)) contained in a computer-readable medium, such as memory 1530, a secondary storage device (e.g., hard disk, Compact Disc-Read Only Memory (CD-ROM), etc.), or other forms of Random Access Memory (RAM) or Read-Only Memory (ROM). A computer-readable medium may be defined as a non-transitory memory device. A memory device may include space within a single physical memory device or spread across multiple physical memory devices. The software instructions may be read into memory 1530 from another computer-readable medium or from another device. The software instructions contained in memory 1530 may cause processor 1520 to perform processes described herein. Alternatively, hardwired circuitry may be used in place of or in combination with software instructions to implement processes described herein. Thus, implementations described herein are not limited to any specific combination of hardware circuitry and software.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing and/or electronic networking environment and may require one or more computing devices, as described in FIG. 14, to complete such actions.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. An apparatus, comprising:
a computing device;
a display screen;
a compartment area; and
a camera,
wherein:
the computing device is configured to receive electronic communications that allow the computing device to change the display screen to show a particular emotion,
the computing device is configured to move from one location to another location,
the computing device is configured to take electronic images via the camera,
wherein:
the electronic images determine a type of activity being conducted by a person, and
the type of activity is determined by a particular time.

2. The apparatus of claim 1, wherein the display screen is configured to display color, facial gestures, and the computing device is further configured to generate a voice with a particular tone.

3. The apparatus of claim 1, wherein the computing device is configured to determine the type of activity based on the geographic location of the computing device and language spoken in the geographic location.
